(19) United States
(12) Patent Application Publication
(10) Pub. No.: US 2009/0125237 A1
(43) Pub. Date: May 14, 2009

(54) Monitoring target detecting apparatus associated with collision damage reducing apparatus

(76) Inventors: Tetsuya Kitagawa, Kawasaki-shi (JP); Keiichi Yamamoto, Kawasaki-shi (JP); Toru Ihara, Kawasaki-shi (JP)

Correspondence Address: JACOBSON HOLMAN PLLC, 400 SEVENTH STREET N.W., SUITE 600, WASHINGTON, DC, 20004, US

(21) Appl. No.: 12/289,536

(22) Filed: Oct. 29, 2008

(30) Foreign Application Priority Data
Oct. 29, 2007 (JP) 2007-280344

(51) Int. Cl. G08G 1/16

(52) U.S. Cl. 701/301

(57) ABSTRACT

A monitoring target detecting apparatus, which is associated with a collision damage reducing apparatus, includes designated obstacle detecting means, which is equipped with the vehicle, detecting an object being positioned in the moving direction and having a possibility of a collision with the vehicle to be a designated obstacle; detecting period calculating means obtaining a continuous detecting period, for which the object has been uninterruptedly detected as the designated obstacle; and monitoring target acknowledging means, according to the continuous detecting period obtained by the detecting period calculating means, deciding whether or not the designated obstacle is regarded as a monitoring target that is to be monitored by the damage reducing apparatus, and deciding whether or not the designated obstacle is regarded as an activation cause to activate the equipment activated under control by the damage reducing apparatus.

### BACKGROUND OF THE INVENTION

(1) Field of the Invention

The present invention relates to a monitoring target detecting apparatus associated with a collision damage reducing apparatus.

(2) Description of Related Art

There has been conventionally developed an apparatus (a so-called collision damage reduction braking apparatus) to brake a moving vehicle before the vehicle collides with an obstacle (e.g., a moving or stopping preceding vehicle, or a utility pole) ahead of the vehicle.

There has also been developed an apparatus (a so-called collision warning apparatus) to attract a driver's attention by alarm or by tightening up the seatbelt.

Here, such a collision damage reduction braking device and a collision warning device are collectively called a “collision damage reducing apparatus”.

Specific examples of a collision damage reducing apparatus are disclosed in Patent References 1 and 2 below.

Patent Reference 1 discloses a technique to avoid erroneous operations by retarding the activation timings of brake means (14), a warning unit (13) and other functional units while the vehicle is moving.

Patent Reference 2 estimates the forthcoming course of the vehicle incorporating the collision damage reducing apparatus and judges the possibility of a collision of the vehicle with an obstacle on the basis of the positional relationship between the estimated course and an obstacle in order to avoid misjudgment on the contact possibility with the obstacle.

[Patent Reference 1] Japanese Patent Application Laid-Open (KOKAI) No. 2007-137126

[Patent Reference 2] Japanese Patent Application Laid-Open (KOKAI) No. 2004-38245

### SUMMARY OF THE INVENTION

Techniques of both Patent References 1 and 2 have a common object to avoid inessential operations of the warning unit and a braking unit by the driver.

However, the technical concepts of Patent Reference 1 and 2 cannot attain the above object in some cases. For example, when the vehicle in question is moving on a straight road which has a curve ahead with a pole positioned at the side, it is difficult for the techniques of the Patent References to exclude the pole from objects requiring a warning or automatic braking by means of operation delay due to driving operations or a collision possibility judgment based on an estimated course of the vehicle.

In particular, if a non-moving object exemplified by the pole in this case is included in monitoring targets, there is a possibility of erroneous detection.

With the foregoing problems in view, the object of the present invention is to provide a monitoring target detecting apparatus associated with a collision damage reducing apparatus enabled to suppress unnecessary operation of equipment of the vehicle by the driver under various road traffic conditions.

To attain the above object, there is provided a monitoring target detecting apparatus associated with a damage reducing apparatus, which is for lessening damage of a vehicle due to a collision, monitoring an obstacle in a moving direction of a vehicle and activating a piece of equipment of the vehicle according to a possibility of a collision with the monitored object, the monitoring target detecting apparatus comprising: designated obstacle detecting means, with which the vehicle is equipped, detecting an object being positioned in the moving direction and having a possibility of a collision with the vehicle to be a designated obstacle; detecting period calculating means obtaining a continuous detecting period, for which the object has been uninterruptedly detected as the designated obstacle; and monitoring target acknowledging means, according to the continuous detecting period obtained by the detecting period calculating means, deciding whether or not the designated obstacle is regarded as a monitoring target that is to be monitored by the damage reducing apparatus, and deciding whether or not the designated obstacle is regarded as an activation cause to activate the equipment activated under control by the damage reducing apparatus. That makes it possible to suppress unnecessary operation of equipment of the vehicle for the driver under various road traffic conditions.

The monitoring target detecting apparatus according to Claim 1 may further include reliability determining means defining a reliability level coefficient indicating a degree of reliability of the designated obstacle and increasing the reliability level coefficient according to increase in the continuous detecting period, and the monitoring target acknowledging means may, according to the reliability level coefficient determined by the reliability determining means, decide whether or not the designated obstacle is regarded as the monitoring target, and decide whether or not the designated obstacle is regarded as the activation cause to activate the equipment activated under control of the damage reducing apparatus. As a consequence, a variation in a reliability level of a monitoring target according to the length of the continuous detecting period of the monitoring target can improve the accuracy in operations performed by the collision damage reducing apparatus.

In the monitoring target detecting apparatus according to Claim 2, the equipment may include a warning unit warning a driver of the vehicle, and an automatic brake control unit controlling for braking of the vehicle irrespective of the driver's intention, and the monitoring target acknowledging means may, if the reliability level coefficient is bigger than a first threshold value, decide the designated obstacle to be regarded as the activation cause to activate the warning unit and the automatic brake control unit, if the reliability level coefficient is equal or smaller than a second threshold value, which is smaller than the first threshold value, decide the designated obstacle not to be regarded as the activation cause to activate the warning unit and the automatic brake control unit, and if the reliability level coefficient is bigger than the second threshold value and equal to or smaller than the first threshold value, decide the designated obstacle to be regarded as the activation cause to activate the warning unit and deciding the designated obstacle not to be regarded as the activation cause to activate the automatic brake control unit. With this configuration, it is possible to properly activate the warning unit and the automatic brake control unit in a case requiring the aid of the warning unit and the automatic brake control unit.

### BRIEF DESCRIPTION OF THE DRAWINGS

The nature of this invention, as well as other objects and advantages thereof, will be explained in the following with reference to the accompanying drawings, in which reference characters designate the same or similar parts throughout the figures and wherein:

FIG. 1 is a block diagram schematically illustrating the entire configuration of a monitoring target detecting apparatus associated with a collision damage reducing apparatus according to a first embodiment of the present invention;

FIG. 2 is a reliability level map to define a reliability level of a monitoring target determined by the monitoring target detecting apparatus associated with the collision damage reducing apparatus;

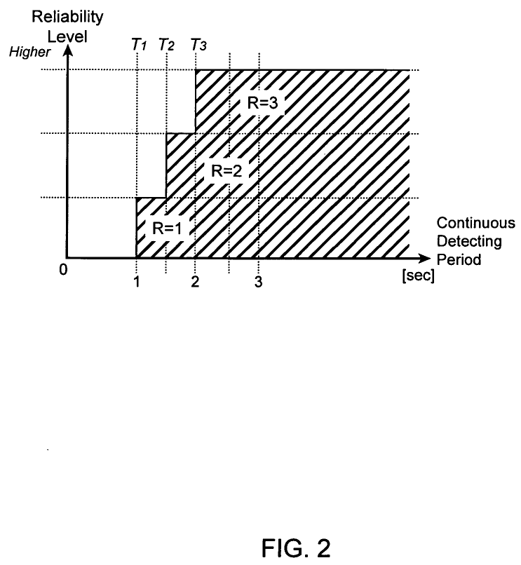

FIG. 3 is a flowchart showing a succession of procedural steps performed by the monitoring target detecting apparatus associated with the collision damage reducing apparatus; and

FIG. 4 is a diagram schematically showing a state in which a vehicle with the collision damage reducing apparatus is moving; and

FIG. 5 is a graph showing an accuracy of detection by the monitoring target detecting apparatus associated with the collision damage reducing apparatus.

### DESCRIPTION OF THE PREFERRED EMBODIMENTS

Hereinafter, an embodiment of a monitoring target detecting apparatus associated with a collision damage reducing apparatus of the present invention will now be described with reference to the accompanying drawings.

### (a) First Embodiment

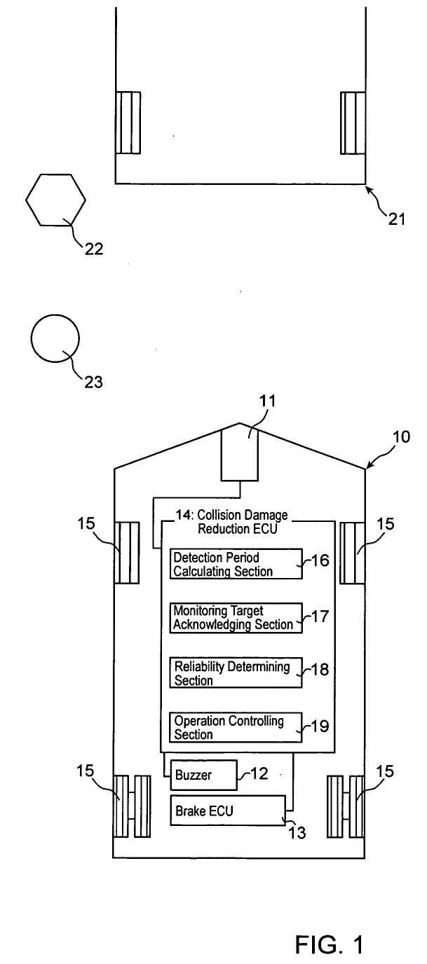

As shown in FIG. 1, vehicle 10 comprises millimeter wave radar unit (designated obstacle detecting means) 11, buzzer 12, brake ECU 13, and damage reduction ECU 14.

Millimeter wave radar unit 11 is positioned in proximity to the front end of vehicle 10, and emits a millimeter radio wave and receives radio waves reflected by an object ahead of vehicle 10, so that the object is detected to be an obstacle (designated obstacle). Millimeter wave radar unit 11 is coupled to damage reduction ECU 14 to be detailed below via a communication cable (not shown) conforming to the CAN (Controller Area Network) standard.

Millimeter wave radar unit 11 is able to simultaneously detect a number of obstacles.

Further, millimeter wave radar unit 11 includes a radar ECU, which does not appear in the drawings.

The radar ECU calculates the relative distance L_{R} between vehicle 10 and an obstacle, and the relative velocity V_{R} between vehicle 10 and the obstacle on the basis of the received radio wave. The radar ECU further determines whether a detected obstacle is moving or not, immobile or not, or moving but about to halt or not, and outputs the result of the determination to damage reduction ECU 14.

Buzzer 12 is a warning unit positioned inside (not shown) vehicle 10, and arouses the driver's attention of vehicle 10 by making an alarm sound. Buzzer 12 is coupled to damage reduction ECU 14 via a harness and is made functional by electricity supplied from damage reduction ECU 14.

Brake ECU (automatic brake unit; equipment) 13 is an electronic control unit that controls brake devices (not shown) provided one for each of wheels 15 of vehicle 10. Brake ECU 13 is coupled to damage reduction ECU 14 via a communication cable conforming to the CAN standard and thereby functions under control of damage reduction ECU 14.

Damage reduction ECU 14 is an electronic control unit comprising a CPU, a memory, an interface unit and other elements, which do not however appear in the drawings. Damage reduction ECU 14 further comprises detection period calculating section (detecting period calculating means) 16, monitoring target acknowledging section (monitoring target acknowledging means) 17, reliability determining section (reliability determining means) 18, and operation controlling section (operation controlling means) 19, which are realized by means of software.

Among these functional sections, detection period calculating section 16 calculates a continuous detecting period ΣT_{D} for which an obstacle has continuously been detected by millimeter wave radar unit 11.

Reliability determining section 18 determines a reliability level coefficient R of a monitoring target according to a continuous detecting period ΣT_{D} calculated by detection period calculating section 16.

Specifically, if a continuous detecting period ΣT_{D} (of a monitoring target) is in excess of the first time period T₁, but is equal to the second time period T₂ (e.g. T₂=1.5 seconds) or shorter (i.e., T₁<ΣT_{D}≦T₂), reliability determining section 18 determines the reliability of the monitoring target to be “relatively low” and sets the reliability level coefficient R to be 1.

In addition, if a continuous detecting period ΣT_{D} (of a monitoring target) is longer than the second time period T₂ but is equal to the third time period T₃ (e.g. T₃=2 seconds) or shorter (i.e., T₂<ΣT_{D}≦T₃), reliability determining section 18 determines the reliability of the monitoring target to be “relatively high” and sets the reliability level coefficient R to be 2.

Further, if a continuous detecting period ΣT_{D} (of a monitoring target) is longer than the third time period (i.e., T₃<ΣT_{D}), reliability determining section 18 determines the reliability of the monitoring target to be “extremely high” and sets the reliability level coefficient R to be 3.

Monitoring target acknowledging section 17 sets an obstacle detected by millimeter wave radar unit 11 to be a monitoring target of operation controlling section (collision damage reducing apparatus) 19 that is to be detailed below considering a reliability level coefficient R determined by monitoring target acknowledging section 17, and concurrently judges whether or not the obstacle should be set to be an activation cause to activate buzzer (equipment) 12 and/or brake ECU (equipment) 13.

More specifically, if a reliability level coefficient R determined by reliability determining section 18 is equal to 0 (the second threshold value) or smaller (R≦0), monitoring target acknowledging section 17 does not determine the obstacle to be an activation cause which activates both buzzer 12 and an object which activates brake ECU 13.

If the reliability level coefficient R is in excess of 0 and is equal to 1 (the first threshold) or smaller (0<R≦1), monitoring target acknowledging section 17 determines the obstacle to be an activation cause to activate buzzer 12 but does not determine the same obstacle to be an activation cause to activate brake ECU 13.

Further, if reliability level coefficient R is bigger than 1 and is equal to 2 (the third threshold) or smaller (1<R≦2), monitoring target acknowledging section 17 determines the obstacle to be an activation cause to activate buzzer 12 and to be an activation cause to activate brake ECU 13 in warning the driver.

Still further, if reliability level coefficient R is bigger than 2 (R>2), monitoring target acknowledging section 17 determines the obstacle to be an activation cause to activate buzzer 12 and to be an activation cause to activate brake ECU 13 in braking vehicle 10.

Consequently, requirement of a higher reliability level for an operation that has more impact on the moving of vehicle 10 can further effectively avoid erroneous detection of an obstacle and can further effectively prevent buzzer 12 and brake ECU 13 from incorrectly warning the driver and incorrectly braking vehicle 10.

Operation controlling section 19 estimates an emergency level (a collision avoidance emergency level) to take action to avoid a collision of vehicle 10 with an obstacle or, in the event of a collision of vehicle 10 with an obstacle, an emergency level (a damage reduction emergency level) to take action to reduce damage caused from the collision considering the relative distance L_{R} between the obstacle and vehicle 10 and the relative velocity V_{R} between the obstacle and vehicle 10 which have been obtained by millimeter wave radar unit 11.

The collision avoidance emergency level and the damage reduction emergency level are collectively called a countermeasure emergency level.

Operation controlling section 19 attracts the driver's attention and activates the brake unit according to the countermeasure emergency level.

More specifically, operation controlling section 19 estimates that the countermeasure emergency level is higher if the relative distance L_{R} between the obstacle and vehicle 10 is shorter and that the countermeasure emergency level is higher if the relative velocity V_{R} between the obstacle and vehicle 10 is higher.

If the countermeasure emergency level is relatively low, operation controlling section 19 rings buzzer 12 to attract the driver's attention.

In addition to ringing buzzer 12, operation controlling section 19 instructs brake ECU 13 to activate the brake devices for the purpose of warning if the countermeasure emergency level is relatively high. The instruction to activate the brake devices for the purpose of warning prompts vehicle 10 to decelerate at 0.3 G (i.e., accelerates at approximately −0.3 G).

If the countermeasure emergency level is extremely high, operation controlling section 19 instructs brake ECU 13 to activate the brake devices for the purpose of emergency braking. Here, the instruction to activate the brake devices for the purpose of emergency braking prompts vehicle 10 to decelerate at 0.6 G (i.e., accelerates at approximately −0.6 G).

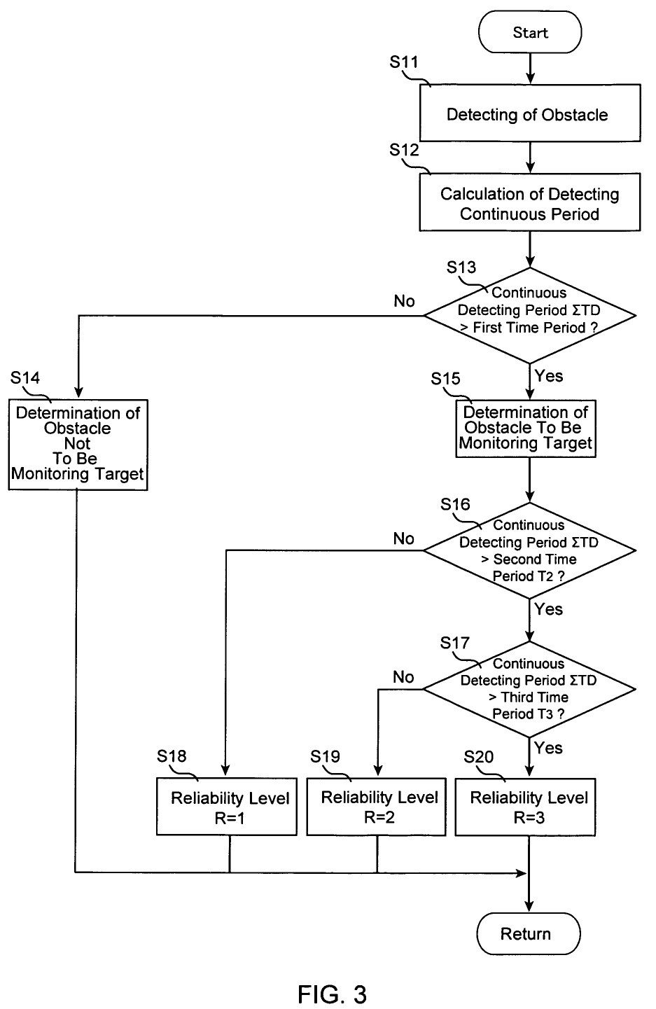

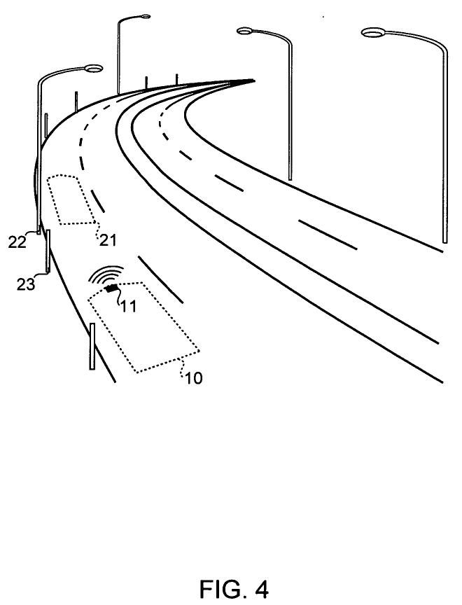

The monitoring target detecting apparatus associated with the collision damage reducing apparatus according to the first embodiment of the present invention has the configuration detailed above and therefore attains the following effects and advantages. Here, the description of an exemplary usage is made along the flow diagram in FIG. 3 with reference to FIGS. 1 and 4.

As shown in FIG. 3, millimeter wave radar unit 11 mounted on vehicle 10 is activated to detect an obstacle (step S11).

In other words, preceding vehicle 21 running ahead of vehicle 10, and utility poles 22 and 23 that are on the road side are detected to be obstacles by millimeter wave radar unit 11, as shown in FIGS. 1 and 4.

After that, detection period calculating section 16 calculates a time length, for which each of preceding vehicle 21, utility pole 22, and pole 23 has been continuously detected to be an obstacle by millimeter wave radar unit 11, that is, for a continuous detecting period ΣT_{D} (step S12).

Then, monitoring target acknowledging section 17 judges whether or not the continuous detecting period ΣT_{D} calculated for each obstacle by detection period calculating section 16 is equal to or shorter than the first time period T₁ (e.g., T₁=1 second).

If the continuous detecting period ΣT_{D} is equal to or shorter than the first time period T₁ (No route in step S13), monitoring target acknowledging section 17 concludes that the obstacle need not be determined to be a monitoring target and operation controlling section 19 does not therefore determine the obstacle to be a monitoring target (step S14).

On the other hand, if the continuous detecting period ΣT_{D} is longer than the first time period T₁ (Yes route in step S13), monitoring target acknowledging section 17 concludes that the obstacle needs to be regarded as a monitoring target and operation controlling section 19 therefore determines the obstacle to be a monitoring target (step S15).

Explanation will be made with reference to the example shown in FIGS. 1 and 4, assuming that moving vehicle 10 passes by the side of utility poles 22 and 23 in a moment. At that time, if a time period (continuous detecting period ΣT_{D}) for which millimeter wave radar unit 11 has continuously detected the utility poles 22 and 23 to be obstacles is very short (e.g., 0.7 seconds), the continuous detecting period ΣT_{D} (i.e., 0.7 seconds) for each of utility poles 22 and 23 is less than the first time period T₁ so that utility pole 22 and pole 23 are not determined to be monitoring targets.

In the meanwhile, assuming that millimeter wave radar unit 11 has continuously detected preceding vehicle 21 to be an obstacle for a relatively long time period (e.g., 40 seconds), since a continuous detecting period ΣT_{D} (i.e., 40 seconds) longer than the first time period T₁, preceding vehicle 21 becomes a monitoring target of operation controlling section 19.

Reliability determining section 18 then judges whether or not the continuous detecting period ΣT_{D} is longer than the second time period T₂ (e.g., T₂=1.5 seconds) as shown in step S16 in FIG. 3. Here, if the continuous detecting period ΣT_{D} is judged to be equal to or shorter than the second time period T₂ (No route in step S16), reliability determining section 18 determines the reliability level of the monitoring target to be relatively low and sets the reliability level coefficient R to be 1 (step S18).

Conversely, if the continuous detecting period ΣT_{D} is judged to be longer than the second time period T₂ (Yes route in step S16), reliability determining section 18 further judges whether or not the continuous detecting period ΣT_{D} is longer than the third time period T₃ (e.g., T₃=2 seconds) (step S17).

Here, if the continuous detecting period ΣT_{D} is judged to be equal to or shorter than the third time period T₃ (No route in step S17), reliability determining section 18 determines that the reliability level of the monitoring target acknowledged by monitoring target acknowledging section 17 is relatively high and sets the reliability level coefficient R to be 2 (step S19).

On the other hand, if t the continuous detecting period ΣT_{D} is judged to be longer than the third time period T₃ (Yes route in step S17), reliability determining section 18 determines that the reliability level of the monitoring target acknowledged by monitoring target acknowledging section 17 is extremely high and sets the reliability level coefficient R to be 3 (step S20).

Here, description continues with reference back to FIGS. 1 and 4.

As described above, the continuous detecting period ΣT_{D} of preceding vehicle 21 is about 40 seconds. In other words, the continuous detecting period ΣT_{D} of preceding vehicle 21 is longer than the second time period T₂ (Yes route in step S16) and further longer than the third time period T₃ (Yes route in step S17). Accordingly, preceding vehicle 21 is regarded as a monitoring target with an extremely high reliability level and therefore, the reliability level coefficient R of preceding vehicle 21 is set to be 3 (step S20).

Operation controlling section 19 functions on the basis of the results of steps S14, S18, S19, and S20 in the flow diagram shown in FIG. 3. Specifically, operation controlling section 19 estimates that the countermeasure emergency level is higher if the relative distance L_{R} between the obstacle and vehicle 10 is shorter and that the countermeasure emergency level is higher if the relative velocity V_{R} between the obstacle and vehicle 10 is higher.

In this case, assuming that vehicle 10 is moving at a higher speed than preceding vehicle 21, the relative distance L_{R} is gradually becoming shorter. Operation controlling section 19 estimates that the countermeasure emergency level is higher in accordance with decrease in the relative distance L_{R} between preceding vehicle 21 and vehicle 10, and that the countermeasure emergency level is higher in accordance with increase in the relative velocity V_{R} between preceding vehicle 21 and vehicle 10.

Further, since monitoring target acknowledging section 17 determines preceding vehicle 21 to be a monitoring target, operation controlling section 19 estimates the countermeasure emergency level of preceding vehicle 21 considering the reliability level coefficient R (i.e., R=3) set for preceding vehicle 21 by reliability determining section 18.

After that, operation controlling section 19 takes countermeasures to avoid a collision of vehicle 10 with preceding vehicle 21 or to reduce the possible damage likely to occur in the event of a collision of vehicle 10 with preceding vehicle 21 by ringing buzzer 12 to arouse the driver's precaution and by activating the brake devices according to the estimated countermeasure emergency level.

Here, the first embodiment of the present invention is further compared to the techniques disclosed in above Patent References 1 and 2.

The techniques disclosed in above Patent References 1 and 2 estimate the possibility of a collision of the vehicle with an obstacle or vary the timing to activate the brake devices and a warning unit, but do not select a monitoring target of the collision damage reducing apparatus among obstacles detected by a millimeter wave radar or a laser radar.

In the above conventional techniques, calculation of collision possibilities with all the obstacles detected by a millimeter wave radar or a laser radar increases the processing load on the collision damage reducing apparatus.

Conversely, the first embodiment of the present invention determines whether or not one or more of preceding vehicle 21, utility pole 22, and pole 23 that are detected to be obstacles positioned ahead of moving vehicle 10 needs to be regarded as a monitoring target of operation controlling section (collision damage reducing apparatus) 19 with high accuracy. With this configuration, it is possible to prevent the processing load on operation controlling section 19 from increasing.

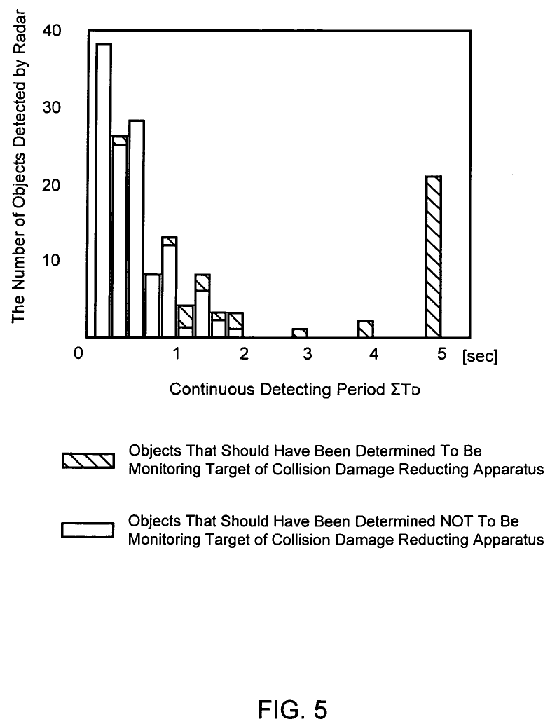

Reliability determining section 18 determines a reliability level coefficient R of a monitoring target according to the length of the continuous detecting period ΣT_{D}, and monitoring target acknowledging section 17 determines the monitoring target to be an activation cause to activate buzzer 12 and brake ECU 13 in the illustrated example. Though the processes accomplished by the functional sections 17 and 18 are relatively simple, the accuracy of the processes is considerably high. The above point will be detailed with reference to FIG. 5, which represents the collective result of experiments conducted using five test vehicles each including a millimeter wave radar unit, a drive data recorder, a motion picture camera and a motion picture recorder.

The graph in FIG. 5 shows the number of objects which the millimeter wave radar has captured to be obstacles for each range of a time period (i.e., a continuous detecting period ΣT_{D}) for which the millimeter wave radar has continuously detected an obstacle.

A hatched bar in FIG. 5 represents the number of objects which should have been determined to be monitoring targets because the objects were required for the aid of the collision damage reducing apparatus. Conversely, a white solid bar represents the number of objects which should not have been determined to be monitoring targets because the objects were not require for the aid of the function of the collision damage reducing apparatus. The requirement for the aid of the collision damage reducing apparatus is determined by Inventors' visible check of the motion picture obtained by use of motion picture cameras and/or motion picture recorders, information of moving states of the test vehicles recorded by the drive data recorders, information provided from the drivers, and others.

For example, if the warning and/or the automatic braking have been activated by the presence of a pole or a utility pole positioned outside the lane through which the vehicle was running, the requirement is determined in view of whether or not the driver has been annoyed by the activation or whether or not the warning should have actually been issued.

As shown in the graph of FIG. 5, the number of captured objects that should be regarded as monitoring targets gradually increases when the continuous detecting period ΣT_{D} comes to be 1 second or longer, and all the captured objects should be determined to be monitoring targets when the continuous detecting period ΣT_{D} comes to be 4 seconds or longer.

As understood from the above result, monitoring target acknowledging section 17 and reliability determining section 18 function with considerable accuracy although the functions are quite simple.

Since determination of a reliability level coefficient R of a monitoring target according to the length of the continuous detecting period ΣT_{D} by reliability determining section 18 and determination of the monitoring target to be an activation cause to activate buzzer 12 and brake ECU 13 by monitoring target acknowledging section 17 are relatively simple, damage reduction ECU 14 can avoid increase in processing load thereon.

By preventing the processing load on operation controlling section 19 from increasing, operation controlling section 19 can send proper instructions to buzzer 12 and brake ECU 13 without delay.

The above prevention makes it possible to suppress the consumption of electricity by damage reduction ECU 14 and suppress the resultant heat emitted from damage reduction ECU 14.

Variation in a reliability level of a monitoring target according to the length of the continuous detecting period ΣT_{D} of the monitoring target can improve the accuracy in operations performed by operation controlling section 19.

The first embodiment of the present invention has been detailed as above, but the present invention should by no means be limited to the foregoing embodiment. Various changes and modifications can be suggested without departing from the gist of the present invention.

For example, the first embodiment detects obstacles with millimeter wave radar unit 11, to which the present invention is not limited and which may be substituted by a laser radar (infrared radar) or a camera.

In the first embodiment, damage reduction ECU 14 is coupled to millimeter wave radar unit 11, buzzer 12, and brake ECU 13 via communication cables conforming to the CAN standard. The connection cable is however not limited to CAN-standard cables, but may alternatively be cables conforming to the LIN (Local Interconnect Network) standard, the IDB-1394 standard, or other standards.

The first embodiment sets the first time period T₁, the second time period T₂ and the third time period T₃ to be 1 second, 1.5 seconds, and 2 seconds, respectively, to which the time periods are however not limited.

Further, in the first embodiment, operation controlling section 19 controls buzzer 12 and brake ECU 13, but the present invention is not limited to this. Alternatively operation controlling section 19 may control the seatbelt pretensioner to warn the driver or to further surely restrain the driver

From the invention thus described, it will be obvious that the same may be varied in many ways. Such variations are not regarded as a departure from the spirit and scope of the invention, and all such modifications as would be obvious to one skilled in the art are intended to be included within the scope of the following claims.

What is claimed is:

1. A monitoring target detecting apparatus associated with a collision damage reducing apparatus, which is for lessening damage of a vehicle due to a collision, monitoring an obstacle in a moving direction of a vehicle and activating a piece of equipment of the vehicle according to a possibility of a collision with the monitored object, said monitoring target detecting apparatus comprising:
designated obstacle detecting means, which is equipped with said vehicle, detecting an object being positioned in the moving direction and having a possibility of a collision with the vehicle to be a designated obstacle;
detecting period calculating means obtaining a continuous detecting period, for which the object has been uninterruptedly detected as the designated obstacle; and
monitoring target acknowledging means, according to the continuous detecting period obtained by said detecting period calculating means, deciding whether or not the designated obstacle is regarded as a monitoring target that is to be monitored by said damage reducing apparatus, and deciding whether or not the designated obstacle is regarded as an activation cause to activate the equipment activated under control by said damage reducing apparatus.

2. The monitoring target detecting apparatus according to claim 1, further comprising;
reliability determining means defining a reliability level coefficient indicating a degree of reliability of the designated obstacle and increasing the reliability level coefficient according to increase in the continuous detecting period,
wherein,
said monitoring target acknowledging means, according to the reliability level coefficient determined by said reliability determining means, decides whether or not the designated obstacle is regarded as the monitoring target, and decides whether or not the designated obstacle is regarded as the activation cause to activate the equipment activated under control of said damage reducing apparatus.

3. The monitoring target detecting apparatus according to claim 2, wherein,
said equipment includes,
a warning unit warning a driver of the vehicle, and
an automatic brake control unit controlling for braking of the vehicle irrespective of the driver's intention,
said monitoring target acknowledging means,
if the reliability level coefficient is bigger than a first threshold value, decides the designated obstacle to be regarded as the activation cause to activate the warning unit and the automatic brake control unit,
if the reliability level coefficient is equal to or smaller than a second threshold value, which is smaller than the first threshold value, decides the designated obstacle not to be regarded as the activation cause to activate the warning unit and the automatic brake control unit, and
if the reliability level coefficient is bigger than the second threshold value and equal to or smaller than the first threshold value, decides the designated obstacle to be regarded as the activation cause to activate the warning unit and deciding the designated obstacle not to be regarded as the activation cause to activate the automatic brake control unit.
